(19) United States
(12) Patent Application Publication
(10) Pub. No.: US 2016/0004379 A1
(43) Pub. Date: Jan. 7, 2016

(54) MANIPULATION INPUT DEVICE, PORTABLE INFORMATION TERMINAL, METHOD FOR CONTROL OF MANIPULATION INPUT DEVICE, AND RECORDING MEDIUM

(71) Applicant: SHARP KABUSHIKI KAISHA, Osaka-shi, Osaka (JP)

(72) Inventor: Toshiyuki UEDA, Osaka-shi (JP)

(73) Assignee: Sharp Kabushiki Kaisha, Osaka-shi, Osaka (JP)

(21) Appl. No.: 14/772,510

(22) PCT Filed: Jul. 22, 2014
(86) PCT No.: PCT/JP2014/069303

§ 371 Date: Sep. 3, 2015

(30) Foreign Application Priority Data
Sep. 5, 2013 (JP) 2013-184361

(51) Int. Cl. G06F 3/041

(52) U.S. Cl. CPC G06F 3/0416; G06F 2203/04108; G06F 2203/04105

(57) ABSTRACT

An operation input device (1) determines an operation instruction with respect to an operation target based on (i) a position detected by a position detection section (11, 13) for detecting a position on an operation acceptance plane (11) which position is pointed by an operation instructor and (ii) a state determined by a state determination section (12, 14) for determining which of a contact state, a proximity state, and a pressing state the operation instructor is in with respect to the operation acceptance plane.

### TECHNICAL FIELD

The present invention relates to a manipulation input device (operation input device) for inputting an operation instruction with respect to an operation target and a portable information terminal including the operation input device. The present invention further relates to a control method, a program, and a recording medium (storage medium) each of which is applicable to the operation input device.

### BACKGROUND ART

Many electronic devices including a touch pad or a touch panel are widely used. Upon receipt of various input operations such as a touch or a gesture, these electronic devices are able to carry out processes associated with the respective input operations.

For example, Patent Literature 1 discloses an information processing device including (i) a first touch pad via which a cursor is moved in an orthogonal direction with respect to a display screen and (ii) a second touch pad via which the cursor is moved in a horizontal direction with respect to the display screen. By using these two touch pads in combination, this information processing device enables a three-dimensional movement.

### CITATION LIST

### Patent Literature

### [Patent Literature 1]

Japanese Patent Application Publication, Tokukai, No. 2009-181595 A (Publication Date: Aug. 13, 2009)

### SUMMARY OF INVENTION

### Technical Problem

However, the technique disclosed in Patent Literature 1 has such a problem that a user is forced to operate the two touch panels at the same time and such operation is troublesome for the user.

The present invention was made in view of the above problem, and has an object to provide an operation input device having improved user-friendliness.

### Solution to Problem

In order to solve the above problem, an operation input device according to one aspect of the present invention includes: an operation acceptance plane for accepting an input operation carried out by an operation instructor; a position detection section for detecting a position on the operation acceptance plane, the position being pointed by the operation instructor; a state determination section for determining which of a contact state, a proximity state, and a pressing state the operation instructor is in with respect to the operation acceptance plane; and an operation instruction determination section for determining an operation instruction with respect to an operation target based on (i) the position detected by the position detection section and (ii) the state determined by the state determination section.

Further, in order to solve the above problem, a method according to one aspect of the present invention for controlling an operation input device is a method for controlling an operation input device which includes an operation acceptance plane for accepting an input operation carried out by an operation instructor, the method including the steps of: (i) detecting a position on the operation acceptance plane, the position being pointed by the operation instructor; (ii) determining which of a contact state, a proximity state, and a pressing state the operation instructor is in with respect to the operation acceptance plane; and (iii) determining an operation instruction with respect to an operation target based on the position detected in the step (i) and the state determined in the step (ii).

### Advantageous Effects of Invention

According to the one aspect of the present invention, it is possible to provide an operation input device having improved user-friendliness.

### BRIEF DESCRIPTION OF DRAWINGS

FIG. 1 is a block diagram showing an example of a configuration of an operation input device according to an embodiment of the present invention.

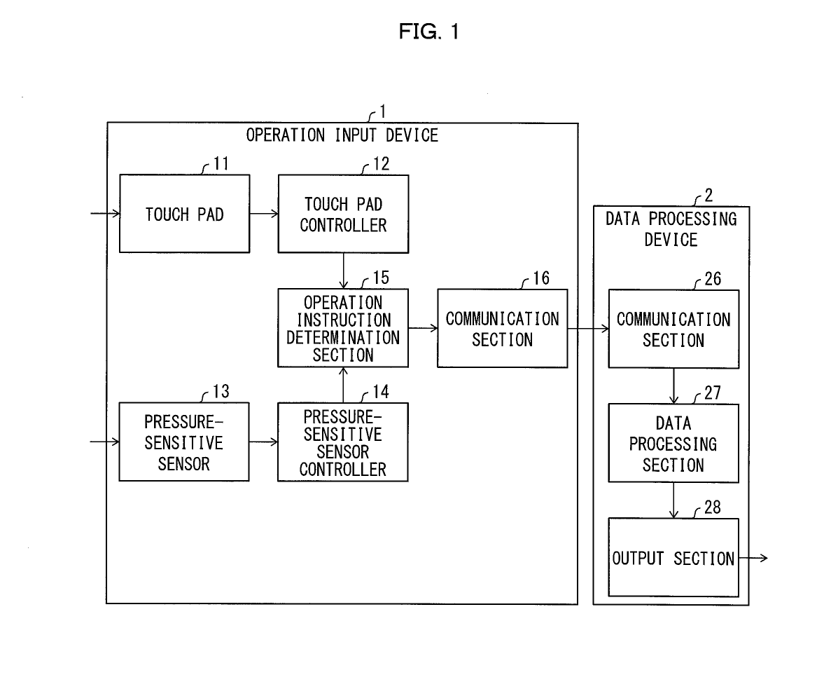

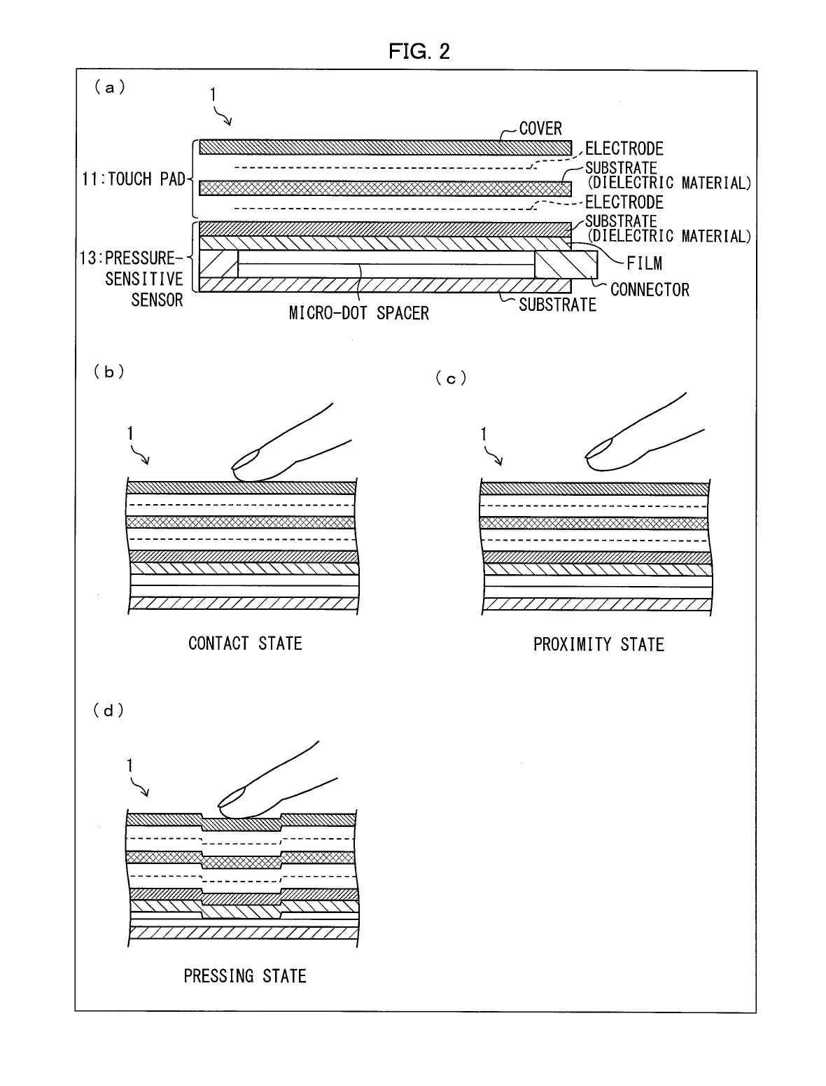

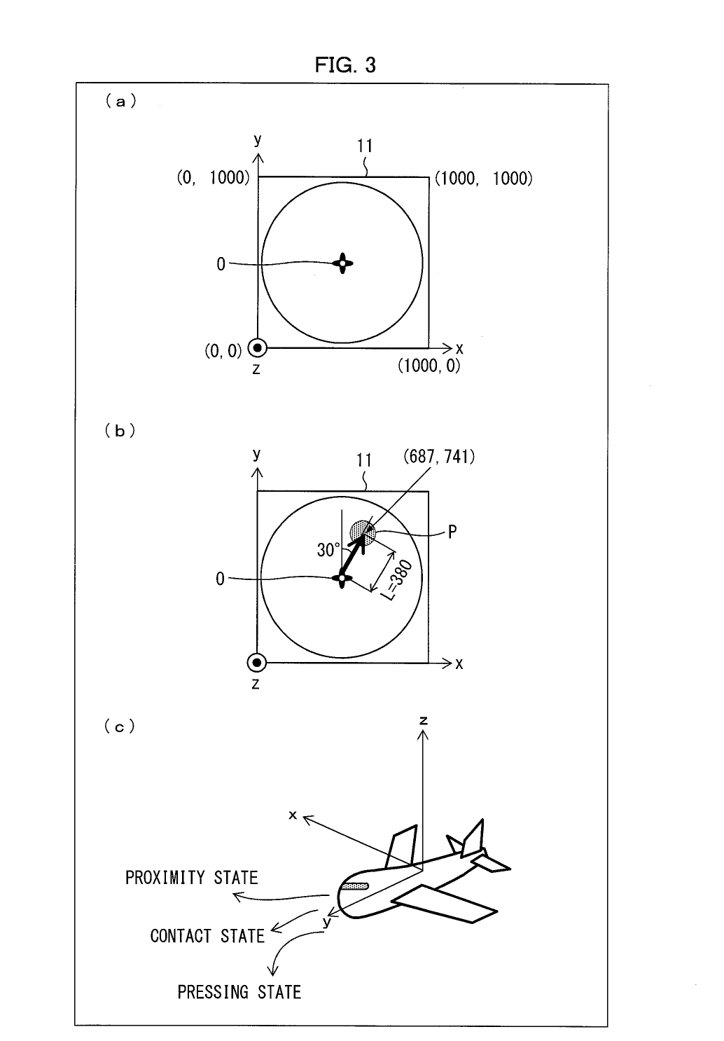

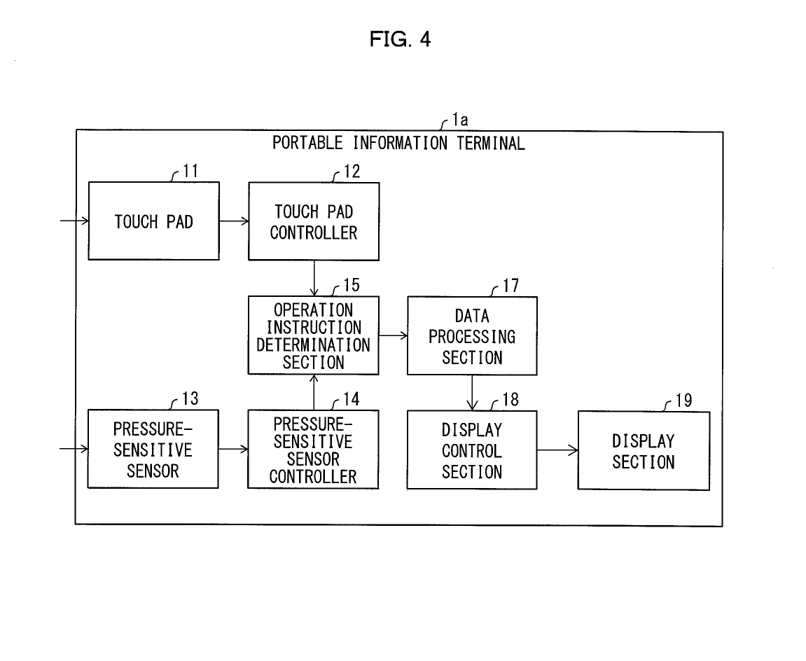

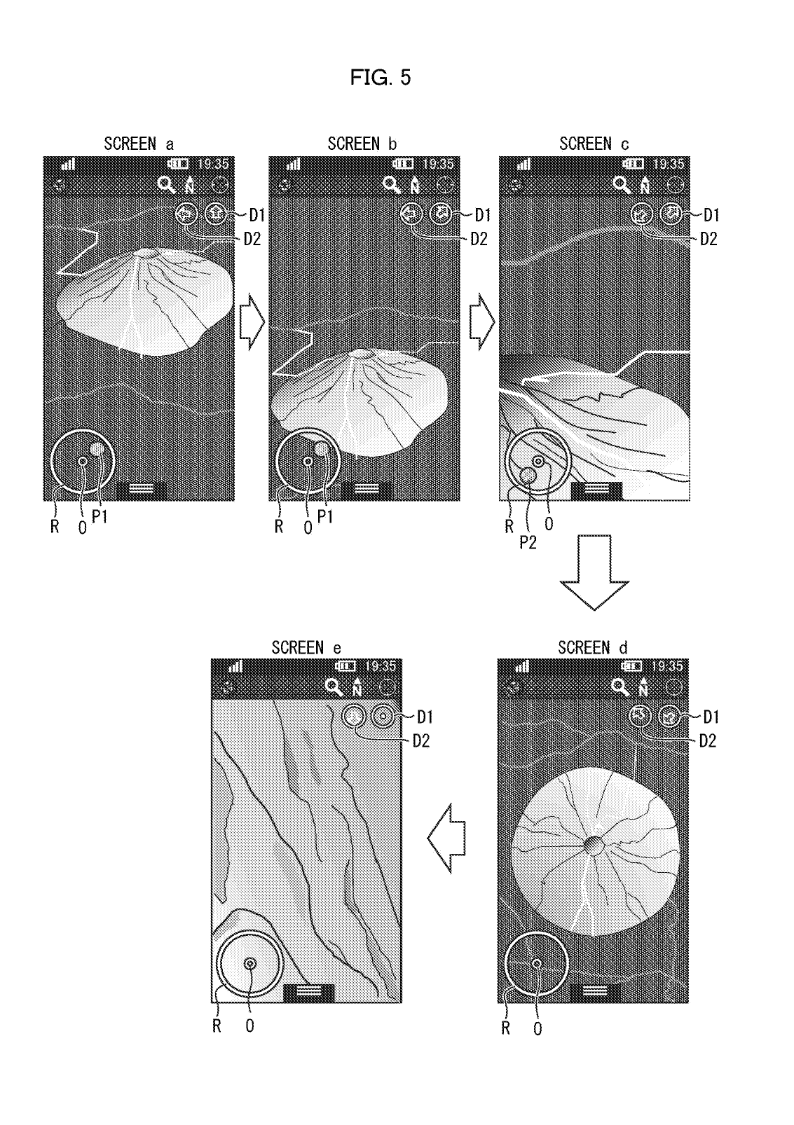

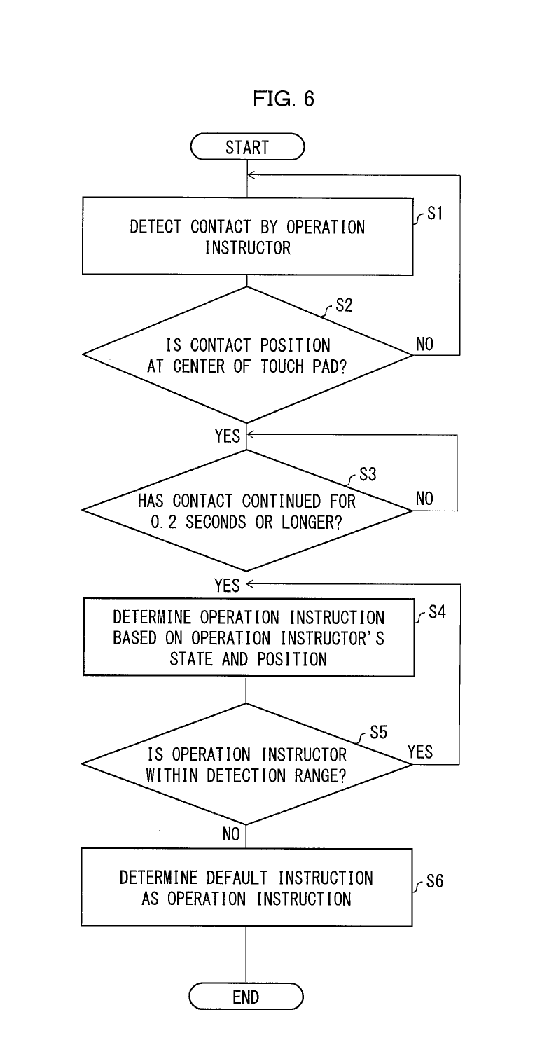

(a) of FIG. 2 is a cross-sectional view illustrating an example of a partial configuration of the operation input device shown in FIG. 1. (b) of FIG. 2 illustrates a state where an operation instructor is in contact with a touch pad shown in (a) of FIG. 2. (c) of FIG. 2 illustrates a state where the operation instructor is in proximity to the touch pad shown in (a) of FIG. 2. (d) of FIG. 2 illustrates a state where the operation instructor is pressing the touch pad shown in (a) of FIG. 2.

(a) of FIG. 3 is a view schematically illustrating a process carried out by an operation instruction determination section included in the operation input device shown in FIG. 1 in order to determine an operation instruction. (b) of FIG. 3 is a view schematically illustrating a process carried out in response to an input operation carried out with respect to a point on the touch pad shown in (a) of FIG. 3. (c) of FIG. 3 is a view schematically illustrating an operation instruction determined by the operation instruction determination section in response to an input operation carried out on the touch pad shown in (a) of FIG. 3.

FIG. 4 is a block diagram illustrating an example of a configuration of a portable information terminal according to an embodiment of the present invention.

FIG. 5 is a view illustrating an example of how a screen displayed by the portable information terminal shown in FIG. 4 is transferred from one to another.

FIG. 6 is a flow chart illustrating how a process is carried out by an operation input device according to an embodiment of the present invention.

### DESCRIPTION OF EMBODIMENTS

### Embodiment 1

With reference to the drawings, the following provides a detailed explanation of Embodiment 1 of the present invention. An operation input device of the present embodiment determines an operation instruction with respect to an operation target that operates in coordination with the operation input device. Further, the operation input device operates, for example, an object (operation target) displayed on a video game machine. In the present embodiment, the operation instruction determined by the operation input device is transmitted to a data processing device. The data processing device carries out a process based on the operation instruction thus transmitted, and outputs a result of the process. For example, in a case where a user gives via the operation input device an instruction to move the operation target, the data processing device carries out a process for moving the operation target. Further, as a result of the process, the data processing device outputs a moving image indicating that the operation target is moving.

(Configuration of Operation Input Device 1)

With reference to FIG. 1, the following explains an operation input device 1 according to the present embodiment. FIG. 1 is a block diagram illustrating a configuration of the operation input device 1 according to the present embodiment. As shown in FIG. 1, the operation input device 1 inputs an operation instruction into the data processing device 2. Note that, in the present embodiment, the operation instruction inputted by the operation input device 1 into the data processing device 2 is an operation instruction to move an object (operation target) displayed on a display device (not illustrated).

As shown in FIG. 1, the operation input device 1 includes a touch pad 11, a touch pad controller 12, a pressure-sensitive sensor 13, a pressure-sensitive sensor controller 14, an operation instruction determination section 15, and a communication section 16.

The touch pad 11 is an operation acceptance plane for accepting an input operation carried out by an operation instructor. The touch pad 11 serves as a contact sensor for accepting an input operation (hereinafter, also referred to as “contact operation”) involving a contact state where the operation instructor (e.g., a finger of the user or a stylus pen) is in contact with the touch pad 11. Further, the touch pad 11 also serves as a proximity sensor for accepting an input operation (hereinafter, also referred to as “proximity operation”) involving a proximity state where the operation instructor is in proximity to the touch pad 11. In a case where the operation instructor exists within a detection range in which a distance between the touch pad 11 and the operation instructor is equal to or shorter than a predetermined distance, the touch pad 11 is able to accept the proximity operation. In the present embodiment, the touch pad 11 is an electric capacitance type, and functions as the contact sensor and the proximity sensor by determining an electric capacitance value. Alternatively, independently of the touch pad 11 serving as the contact sensor, a proximity sensor may be provided. In a case where the touch pad 11 serves as the proximity sensor, the touch pad 11 at least needs to be able to determine whether or not the operation instructor is in proximity to the touch pad 11.

Further, the touch pad 11 detects a position on the touch pad 11 which position is pointed by the operation instructor. In the present embodiment, upon detection of the contact state or the proximity state by the operation instructor, the touch pad 11 detects a contact position or a proximity position on the touch pad 11 which position is pointed by the operation instructor. Here, the proximity position is defined to be a position on the touch pad 11 onto which the operation instructor is projected along the direction of the normal to the touch pad 11. More specifically, the proximity position is defined to be a position on the touch pad 11 which position is indicative of a minimum distance between the operation instructor and the touch pad 11. The touch pad 11 generates position information (X,Y) indicative of coordinate values of the contact position or the proximity position which is detected. The position information (X,Y) generated by the touch pad 11 and the electric capacitance value detected by the touch pad 11 are supplied to the touch pad controller 12.

In a case where the electric capacitance value supplied by the touch pad 11 is equal to or higher than a predetermined threshold, the touch pad controller 12 determines that the operation instructor is in the contact state. Meanwhile, in a case where the electric capacitance value supplied by the touch pad 11 is less than the predetermined threshold, the touch pad controller 12 determines that the operation instructor is in the proximity state. In a case where the touch pad controller 12 determines that the operation instructor is in the contact state, the touch pad controller 12 generates a state value of T=0. Meanwhile, in a case where the touch pad controller 12 determines that the operation instructor is in the proximity state, the touch pad controller 12 generates a state value of T=1. The state value T generated by the touch pad controller 12 and the position information (X,Y) supplied by the touch pad 11 are supplied to the operation instruction determination section 15.

In a case of an input operation (hereinafter, also referred to as “pressing operation”) involving a pressing state where the touch pad 11 is pressed by the operation instructor, the pressure-sensitive sensor 13 detects a pressure value indicative of a degree of the pressing and thus accepts the pressing operation. Further, upon detection of the pressing state by the operation instructor, the pressure-sensitive sensor 13 detects a pressing position on the touch pad 11 which position is pointed by the operation instructor. The pressure-sensitive sensor 13 generates position information (X,Y) indicative of coordinate values of the pressing position which is detected. The position information (X,Y) generated by the pressure-sensitive sensor 13 and the pressure value detected by the pressure-sensitive sensor 13 are supplied to the pressure-sensitive sensor controller 14.

The pressure-sensitive sensor controller 14 converts the pressure value detected by the pressure-sensitive sensor 13 into a value expressed in 1024 stages, i.e., a value from 0 to 1023. Further, based on the value thus converted, the pressure-sensitive sensor controller 14 determines a state of the operation instructor. For example, in a case where the value converted from the pressure value is a low value from 0 to 200, the pressure-sensitive sensor controller 14 determines that the operation instructor is in the contact state. By this arrangement, the pressure-sensitive sensor controller 14 is able to prevent the contact operation intended by the user from being erroneously determined as the pressing operation. On the other hand, in a case where the value converted from the pressure value is in a range from 201 to 1024, the pressure-sensitive sensor controller 14 determines that the operation instructor is in the pressing state, and generates a state value of T=2. The state value T generated by the pressure-sensitive sensor controller 14 and the position information (X,Y) supplied by the pressure-sensitive sensor 13 are supplied to the operation instruction determination section 15.

As described above, in the present embodiment, the touch pad 11 and the pressure-sensitive sensor 13 serve also as a position detection section for detecting a position on the touch pad 11 which position is pointed by the operation instructor. Further, the touch pad controller 12 and the pressure-sensitive sensor controller 14 serve as a state determination section for determining which of the contact state, the proximity state, and the pressing state the operation instructor is in with respect to the touch pad 11.

The operation instruction determination section 15 is an operation instruction determination section for determining, based on (i) the state value and the position information supplied by the touch pad controller 12 or (ii) the state value and the position information supplied by the pressure-sensitive sensor controller 14, an operation instruction to be transmitted to the data processing device 2. The operation instruction determined by the operation instruction determination section 15 is supplied to the communication section 16. A process carried out by the operation instruction determination section 15 in order to determine the operation instruction will be described in detail later with reference to another drawing.

The communication section 16 transmits the operation instruction determined by the operation instruction determination section 15 to a communication section 26 in the data processing device 2. In the present embodiment, the communication section 16 and the communication section 26 communicate with each other via USB (Universal Serial Bus) connection. However, the present invention is not limited to this. Alternatively, for example, the communication section 16 and the communication section 26 may communicate with each other via wireless LAN (Local Area Network) or Bluetooth (Registered Trademark).

As shown in FIG. 1, the data processing device 2 includes the communication section 26, a data processing section 27, and an output section 28. The communication section 26 receives the operation instruction from the communication section 16 in the operation input device 1. The operation instruction thus received is supplied to the data processing section 27. The data processing section 27 carries out a process based on the operation instruction supplied from the communication section 26. A result of the process carried out by the data processing section 27 is supplied to the output section 28. The output section 28 outputs the result of the process carried out by the data processing section 27. In the present embodiment, the data processing device 2 supplies, to the display device (not illustrated), moving image data indicative of a moving image obtained as the result of the process. Note that the data processing device 2 may further include a display section. In this case, the output section 28 supplies, to the display section (not illustrated), the moving image data indicative of the moving image obtained as the result of the process.

Next, with reference to FIG. 2, the following explains a specific configuration of the operation input device 1. (a) of FIG. 2 is a cross-sectional view illustrating an example of a partial configuration of the operation input device 1. In (a) of FIG. 2, an upper side corresponds to a front side of a housing of the operation input device 1 (i.e., a side of the touch pad 11 on which side a touch plane is provided), whereas a lower side corresponds to a back side of the housing of the operation input device 1. Note that the example of the configuration shown in (a) of FIG. 2 is for the purpose of exemplification, and the present invention is not limited to this.

As shown in (a) of FIG. 2, the operation input device 1 includes (i) the touch pad 11 and (ii) the pressure-sensitive sensor 13 provided under the touch pad 11. The touch pad 11 includes a cover which corresponds to the touch plane, a first electrode provided under the cover, and a first substrate provided under the electrode. Further, the touch pad 11 includes a second electrode provided under the first substrate and a second substrate provided under the second electrode. Each of the first substrate and the second substrate is made of a dielectric material.

Further, as shown in (a) of FIG. 2, the pressure-sensitive sensor 13 is provided under the second substrate of the touch pad 11, and includes a film, a micro-dot spacer and a connector provided under the film, and a third substrate provided under the micro-dot spacer.

As shown in (b) of FIG. 2, in a case where the operation instructor such as the finger of the user is in contact with the touch plane of the touch pad 11, the touch pad 11 detects a contact position on the touch pad 11 which position is pointed by the operation instructor. Meanwhile, as shown in (c) of FIG. 2, in a case where the operation instructor is in proximity to the touch pad 11 within the detection range of the touch pad 11, the touch pad 11 detects a proximity position on the touch pad 11 which position is pointed by the operation instructor. Meanwhile, as shown in (d) of FIG. 2, in a case where the operation instructor is pressing the touch plane of the touch pad 11, the touch pad 11 detects a pressing position on the touch pad 11 which position is pointed by the operation instructor.

(Determination of Operation Instruction by Operation Instruction Determination Section 15)

Next, with reference to FIG. 3, the following explains a process carried out by the operation instruction determination section 15 in order to determine an operation instruction. (a) of FIG. 3 is a view schematically illustrating the process carried out by the operation instruction determination section 15 in order to determine an operation instruction. Note that, in (a) of FIG. 3, the touch pad 11 is viewed from the front side of the housing of the operation input device 1 (i.e., from the upper side in (a) of FIG. 2).

As shown in (a) of FIG. 3, coordinate values on an xy plane, which is defined by an x-axis and a y-axis orthogonal to each other relative to an origin located in any one of four corners of the touch pad 11 (in (a) of FIG. 3, the lower left corner), are assigned to the touch pad 11. Further, a reference position O, which is predetermined on the touch pad 11, is indicated in a center of the touch pad 11. In the present embodiment, coordinates of the four corners of the touch pad 11 are (0,0), (0,1000), (1000,0), and (1000,1000), respectively, and coordinates of the reference position O is (500,500). Note that the reference position O corresponds to a current position of the operation target.

With reference to (b) and (c) of FIG. 3, the following provides more specific explanation of how the operation instruction determination section 15 determines an operation instruction. (b) of FIG. 3 is a view schematically illustrating a process carried out in response to an input operation carried out with respect to a point P on the touch pad 11. In the present embodiment, the operation input device 1 determines an operation instruction with respect to an airplane (operation target) displayed on a video game machine. (c) of FIG. 3 is a view schematically illustrating an operation instruction determined by the operation instruction determination section 15 in response to an input operation carried out on the touch pad 11. Assume that, while the operation instruction is not carried out by the operation input device 1 in (c) of FIG. 3, the airplane, which is the operation target, is moving at a constant speed in a y-axis positive direction.

The following explains a case where a proximity operation is carried out with respect to the point P on the touch pad 11 as shown in (b) of FIG. 3. Based on (i) coordinate values (687,741) indicated by position information supplied by the touch pad controller 12 and (ii) the coordinate values (500,500) of the reference position O, the operation instruction determination section 15 calculates a direction of a position detected by the touch pad 11 which direction is relative to the reference position O. A result of the calculation carried out by the operation instruction determination section 15 indicates that, in the example shown in (b) of FIG. 3, the point P exists in a direction extending from the reference position O at an angle of 30° relative to the y-axis in a clockwise direction. Thus, a direction in which the operation target is to be moved on the xy plane is determined by the operation instruction determination section 15 so that the operation target is moved from the current position along a direction inclined at an angle of 30° relative to the y-axis in a clockwise direction.

Further, the “proximity operation” is carried out with respect to the point P in the example shown in (b) of FIG. 3, and therefore a state value T supplied to the operation instruction determination section 15 is T=1. Thus, the operation instruction determination section 15 determines, as a direction in which the operation target is to be moved along a z-axis direction, a z-axis positive direction. Namely, as shown in (c) of FIG. 3, the operation input device 1 makes the airplane, which is the operation target, move upwardly. Meanwhile, in a case where the state value is T=0, the operation instruction determination section 15 determines the operation instruction so that the operation target is not moved in the z-axis direction. Namely, the operation input device 1 makes the airplane, which is the operation target, move on a plane which is in parallel with the xy plane. Meanwhile, in a case where the state value is T=2, the operation instruction determination section 15 determines, as the direction in which the operation target is to be moved along the z-axis direction, a z-axis negative direction. Namely, the operation input device 1 makes the airplane, which is the operation target, move downwardly.

Furthermore, as shown in (b) of FIG. 3, the operation instruction determination section 15 calculates a relative distance L between the position detected by the touch pad 11 and the reference position O, with use of (i) the coordinate values (687,741) indicated by the position information supplied by the touch pad controller 12 and (ii) the coordinate values (500,500) of the reference position O. A result of the calculation carried out by the operation instruction determination section 15 indicates that, in the example shown in (b) of FIG. 3, the point P exists in a position which is away from the reference position O by the distance of L=380. In the present embodiment, the operation instruction determination section 15 determines an acceleration of the operation target in proportion to the distance L which is calculated.

In the above-described manner, the operation instruction determination section 15 determines the operation instruction with respect to the operation target. The operation input device 1 according to the present embodiment allows a user to carry out an operation by intuition, thereby achieving improved user-friendliness. Further, the operation input device 1 according to the present embodiment does not need to include a plurality of touch pads, and therefore it is possible to place the operation input device 1 in a smaller area.

Note that the operation instruction determination section 15 may determine a speed of the operation target in proportion to the distance L which is calculated.

### Embodiment 2

With reference to FIGS. 4 and 5, the following explains Embodiment 2 of the present invention. A portable information terminal (smartphone) according to the present embodiment includes the operation input device of Embodiment 1. In a smartphone according to the present embodiment, a touch pad, which is an operation acceptance plane, and a display section are integrated and serve as a touch panel. Further, in the present embodiment, the smartphone executes, for example, an application (hereinafter, also referred to as “map application”) for displaying a map, and determines an operation instruction to move a position of “view point (operation target)” in an aerial view provided by the map application.

(Configuration of Portable Information Terminal 1a)

FIG. 4 is a block diagram illustrating a configuration of a portable information terminal 1a (hereinafter, also referred to as “smartphone 1a”) according to the present embodiment. For convenience of explanation, members having the same functions as those explained in drawings of Embodiment 1 are given the same signs as Embodiment 1 and explanations thereof are omitted here.

In the present embodiment, a data processing section 17 carries out a process based on an operation instruction supplied by the operation instruction determination section 15. A result of the process carried out by the data processing section 17 is supplied to a display control section 18. The display control section 18 supplies, to a display section 19, moving image data indicative of a moving image obtained as the result of the process. The display section 19 displays the moving image corresponding to the moving image data supplied by the display control section 18.

(Process Carried Out by Smartphone 1a)

Next, with reference to FIG. 5, the following explains a process carried out by the smartphone 1a. FIG. 5 is a view illustrating an example of how a screen displayed by the smartphone 1a is transferred from one to another. The smartphone 1a executes the map application, so as to display a screen a shown in FIG. 5. In the screen a shown in FIG. 5, a region indicated as a region R serves to accept an input operation for instructing to move the view point, and a reference position O is indicated in a center of the region R. Further, in the screen a shown in FIG. 5, D1 indicates a direction in which the view point is moved on an xy plane, whereas D2 indicates a direction in which the view point is moved on a yz plane. Namely, the screen a shown in FIG. 5 shows that the view point is moved in a y-axis positive direction and in a direction in parallel with the xy plane.

In a case where a contact operation with respect to a point P1 is detected while the smartphone 1a displays the screen a shown in FIG. 5, the screen displayed by the smartphone 1a is transferred to a screen b shown in FIG. 5. In the screen b shown in FIG. 5, D1 indicates that the view point is moved on the xy plane in a direction from the reference position O toward the point P1 (diagonally upward right in FIG. 5), whereas D2 indicates that the view point is moved on the yz plane in a direction in parallel with the xy plane.

Next, in a case where a pressing operation with respect to the point P1 is detected while the smartphone 1a displays the screen b shown in FIG. 5, the screen displayed by the smartphone 1a is transferred to a screen c shown in FIG. 5. In the screen c shown in FIG. 5, D1 indicates that the view point is moved on the xy plane in a direction from the reference position O toward the point P1 (diagonally upward right in FIG. 5), whereas D2 indicates that the view point is moved on the yz plane in a z-axis negative direction.

Next, in a case where a proximity operation with respect to the point P2 is detected while the smartphone 1a displays the screen c shown in FIG. 5, the screen displayed by the smartphone 1a is transferred to a screen d shown in FIG. 5. In the screen d shown in FIG. 5, D1 indicates that the view point is moved on the xy plane in a direction from the reference position O toward the point P2 (diagonally downward left in FIG. 5), whereas D2 indicates that the view point is moved on the yz plane in a z-axis positive direction.

Next, in a case where a pressing operation with respect to the reference position O is detected while the smartphone 1a displays the screen d shown in FIG. 5, the screen displayed by the smartphone 1a is transferred to a screen e shown in FIG. 5. In the screen e shown in FIG. 5, D1 indicates that the view point is not moved on the xy plane, whereas D2 indicates that the view point is moved on the yz plane in a z-axis negative direction.

As described above, as with the operation input device 1 according to Embodiment 1, the smartphone 1a according to the present embodiment allows a user to carry out an operation by intuition, thereby achieving improved user-friendliness. Further, the smartphone 1a according to the present embodiment does not need to include a plurality of touch pads, and therefore it is possible to place the operation input device 1a in a further smaller area. The present embodiment has explained a case where the smartphone is employed as the portable information terminal. However, the present invention is not limited to this. For example, the present invention is applicable also to a tablet terminal or a laptop computer each including a touch panel.

In the above description, the “view point” has been explained as the operation target. Alternatively, the “map” can be regarded as the operation target. In this case, the moving direction described when the “view point” is regarded as the operation target is opposite to a moving direction to be described when the map” is regarded as the operation target.

### Embodiment 3

With reference to FIG. 6, the following explains Embodiment 3 of the present invention. In a case where a touch pad 11 determines that an operation instructor is in a contact state with respect to a reference position O for a predetermined period (e.g., 0.2 seconds) or longer, an operation input device 1 according to the present embodiment determines an operation instruction with respect to an operation target based on (i) a position detected by the touch pad 11 and a pressure-sensitive sensor 13 after the touch pad's determination and (ii) a state determined by a touch pad controller 12 and a pressure-sensitive sensor controller 14 after the touch pad's determination, for the purpose of preventing misoperation. Here, the contact operation with respect to the reference position O is an instruction not to move the operation target on an xy plane and along a z-axis, and thus such a contact operation is hereinafter also called as “default operation instruction”. By this arrangement, it is possible to prevent misoperation caused by determining, as a proximity input, a proximity state which is not intended by a user.

FIG. 6 is a flow chart illustrating how a process is carried out by the operation input device 1 according to the present embodiment. First, the touch pad 11 detects a contact state by the operation instructor (S1). Subsequently, the touch pad controller 12 determines whether or not a contact position pointed by the operation instructor in the contact state detected by the touch pad 11 in S1 corresponds to a center of the touch pad 11, i.e., the reference position O (S2).

If the touch pad controller 12 determines that the contact position does not correspond to the reference position O (NO in S2), the operation input device 1 returns the process to S1. Meanwhile, if the touch pad controller 12 determines that the contact position corresponds to the reference position O (YES in S2), the touch pad controller 12 determines whether or not the contact state has continued for the predetermined period or longer (S3). If the touch pad controller 12 determines that a period for which the contact state has continued is shorter than the predetermined period (NO in S3), the operation input device 1 returns the process to S3. If the touch pad controller 12 determines that the contact state has continued for the predetermined period or longer (YES in S3), the operation instruction determination section 15 determines an operation instruction according to the procedures explained the foregoing embodiments (S4).

While the operation instructor exists within a detection range (YES in S5), the operation input device 1 repeatedly carries out the process in S4. If the operation instructor moves to the outside of the detection range (NO in S5), the operation instruction determination section 15 determines, as the operation instruction, the default operation instruction (S6). Thus, the operation input device 1 ends the process.

As described above, the operation input device 1 according to the present embodiment is able to prevent misoperation caused by determining, as a proximity input, a proximity state which is not intended by a user. Note that the operation input device 1 according to the present embodiment is applicable also to the portable information terminal according to Embodiment 2.

[Example Achieved by Software]

Control blocks (particularly, the touch pad controller 12, the pressure-sensitive sensor controller 14, and the operation instruction determination section 15) of each of the operation input device 1 and the portable information terminal 1a can be realized by a logic circuit (hardware) provided in an integrated circuit (IC chip) or the like or can be alternatively realized by software as executed by a CPU (Central Processing Unit).

In the latter case, each of the operation input device 1 and the portable information terminal 1a includes a CPU that executes instructions of a program that is software realizing the foregoing functions; ROM (Read Only Memory) or a storage device (each referred to as “storage medium”) in which the program and various kinds of data are stored so as to be readable by a computer (or a CPU); and RAM (Random Access Memory) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### SUMMARY

An operation input device 1 according to an aspect 1 of the present invention includes: an operation acceptance plane (touch pad 11) for accepting an input operation carried out by an operation instructor; a position detection section (touch pad 11, pressure-sensitive sensor 13) for detecting a position on the operation acceptance plane, the position being pointed by the operation instructor; a state determination section (touch pad controller 12, pressure-sensitive sensor controller 14) for determining which of a contact state, a proximity state, and a pressing state the operation instructor is in with respect to the operation acceptance plane; and an operation instruction determination section (operation instruction determination section 15) for determining an operation instruction with respect to an operation target based on (i) the position detected by the position detection section and (ii) the state determined by the state determination section. With this arrangement, the operation input device 1 achieves improved user-friendliness.

An operation input device 1 according to an aspect 2 of the present invention is preferably configured such that, in the aspect 1, the operation instruction determination section determines, based on a direction of the position detected by the position detection section, a direction in which the operation target is to be moved on an xy plane, the direction of the position being relative to a reference position which is predetermined on the operation acceptance plane. With this arrangement, the operation input device 1 allows a user to carry out an operation by intuition, thereby achieving further improved user-friendliness.

An operation input device 1 according to an aspect 3 of the present invention is preferably configured such that, in the aspect 2, the operation instruction determination section determines, based on the state determined by the state determination section, a direction in which the operation target is to be moved along a z-axis direction. With this arrangement the operation input device 1 allows a user to carry out an operation by intuition, thereby achieving further improved user-friendliness.

An operation input device 1 according to an aspect 4 of the present invention is preferably configured such that, in the aspect 2 or 3, the operation instruction determination section determines a speed or an acceleration of the operation target based on a relative distance between the position detected by the position detection section and the reference position. With this arrangement, the operation input device 1 allows a user to carry out an operation by intuition, thereby achieving further improved user-friendliness.

An operation input device 1 according to an aspect 5 of the present invention is preferably configured such that, in any one of the aspects 2 through 4, in a case where (i) the state determination section determines that the operation instructor has been in the contact state for a predetermined period and (ii) the position which is pointed by the operation instructor and is detected by the position detection section is the reference position, the operation instruction determination section determines an operation instruction with respect to the operation target based on (i) the state determined by the state determination section after the position detection section's determination and (ii) the position detected by the position detection section after the position detection section's determination. With this arrangement, it is possible to prevent misoperation caused by determining, as a proximity input, a proximity state which is not intended by a user.

A portable information terminal 1a according to an aspect 6 of the present invention includes an operation input device according to any one of the aspects 1 through 5,

A method according to an aspect 7 of the present invention for controlling an operation input device is a method for controlling an operation input device which includes an operation acceptance plane for accepting an input operation carried out by an operation instructor, the method including the steps of: (i) detecting a position on the operation acceptance plane, the position being pointed by the operation instructor; (ii) determining which of a contact state, a proximity state, and a pressing state the operation instructor is in with respect to the operation acceptance plane; and (iii) determining an operation instruction with respect to an operation target based on the position detected in the step (i) and the state determined in the step (ii).

An operation input device according to each aspect of the present invention can be realized by a computer. In this case, the present invention encompasses (i) a program for controlling the operation input device, the program causing the computer to function as each section included in the operation input device so that the operation input device is realized by the computer and (ii) a computer-readable storage medium in which the program is stored.

[Additional Remarks]

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is suitably applicable to an operation input device for inputting an operation instruction with respect to an operation target.

### REFERENCE SIGNS LIST

1 Operation input device
11 Touch pad (operation acceptance plane, position detection section)
12 Touch pad controller (state determination section)
13 Pressure-sensitive sensor (position detection section)
14 Pressure-sensitive sensor controller (state determination section, position detection section)
15 Operation instruction determination section
1a Portable information terminal

1. An operation input device, comprising:
an operation acceptance plane for accepting an input operation carried out by an operation instructor;
a position detection section for detecting a position on the operation acceptance plane, the position being pointed by the operation instructor;
a state determination section for determining which of a contact state, a proximity state, and a pressing state the operation instructor is in with respect to the operation acceptance plane; and
an operation instruction determination section for determining an operation instruction with respect to an operation target based on (i) the position detected by the position detection section and (ii) the state determined by the state determination section.

2. The operation input device as set forth in claim 1, wherein:
the operation instruction determination section determines, based on a direction of the position detected by the position detection section, a direction in which the operation target is to be moved on an xy plane, the direction of the position being relative to a reference position which is predetermined on the operation acceptance plane.

3. The operation input device as set forth in claim 2, wherein:
the operation instruction determination section determines, based on the state determined by the state determination section, a direction in which the operation target is to be moved along a z-axis direction.

4. The operation input device as set forth in claim 2, wherein:
the operation instruction determination section determines a speed or an acceleration of the operation target based on a relative distance between the position detected by the position detection section and the reference position.

5. The operation input device as set forth in claim 2, wherein:
in a case where (i) the state determination section determines that the operation instructor has been in the contact state for a predetermined period and (ii) the position which is pointed by the operation instructor and is detected by the position detection section is the reference position, the operation instruction determination section determines an operation instruction with respect to the operation target based on (i) the state determined by the state determination section after the position detection section's determination and (ii) the position detected by the position detection section after the position detection section's determination.

6. A portable information terminal comprising an operation input device as set forth in claim 1.

7. A method for controlling an operation input device which includes an operation acceptance plane for accepting an input operation carried out by an operation instructor, said method comprising the steps of:
(i) detecting a position on the operation acceptance plane, the position being pointed by the operation instructor;
(ii) determining which of a contact state, a proximity state, and a pressing state the operation instructor is in with respect to the operation acceptance plane; and
(iii) determining an operation instruction with respect to an operation target based on the position detected in the step (i) and the state determined in the step (ii).

8. (canceled)

9. A non-transitory computer-readable storage medium in which a program for causing a computer to function as an operation input device as set forth in claim 1 is stored.
